(19) United States
(12) Patent Application Publication
(10) Pub. No.: US 2002/0049737 A1
(43) Pub. Date: Apr. 25, 2002

(54) Equipment management system, equipment management apparatus, control method therefor, and computer-readable memory

(76) Inventors: Kenichi Sakuma, Tokyo (JP); Motoshi Koike, Tokyo (JP); Teruhiko Fukuda, New York, NY (US); Shuji Suda, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/921,569

(22) Filed: Aug. 6, 2001

(30) Foreign Application Priority Data
Aug. 10, 2000 (JP) 2000-243331

(51) Int. Cl. G06F 7/00

(52) U.S. Cl. 707/1

(57) ABSTRACT

A user terminal transmits failure information about a connected printer to a management server. The management server calculates the repair fee estimate of the equipment on the basis of the transmitted failure information. Estimate information including the calculated repair fee estimate is then transmitted to the user terminal.

### FIELD OF THE INVENTION

The present invention relates to an equipment management system in which the user terminal owned by a user and the server managed by a maker that provides equipment and its expendables for the user are connected to each other through a network, an equipment management apparatus, a control method therefor, and a computer-readable memory.

### BACKGROUND OF THE INVENTION

Conventionally, when equipment such as a printer purchased by a user fails, the user carries the equipment to the nearest service store of the maker that has manufactured the equipment, or directly deliver it to the maker, thus requesting a repair of the equipment. In general, if the equipment is under warranty, the maker repairs it without charge. If the equipment is out of warranty, the maker repairs it with a charge.

With regard to an expendable of equipment, the user goes to a store that handles the expendable and purchases it or obtains it by making contact with the maker.

In repairing the faulty equipment, if the equipment is under warranty, the user prepares a warranty of the equipment and makes a request to repair the equipment. In this case, if the user loses the warranty, the equipment cannot be repaired without charge, or the user must prove that the equipment is under warranty, and the maker must check it. This imposes a burden on both the user and the maker. If the equipment is out of warranty, the equipment is to be repaired with a charge. In this case, when the equipment is delivered from the user to the maker, the maker makes an estimate and checks the consent of the user with respect to the estimate. If the consent is made, the maker makes arrangements for a repair shop or the like. For this reason, it takes much time for the user to receive the repaired equipment after making a request to repair the faulty equipment. The user finds it inconvenient.

In addition, if an expendable of the equipment is not handled by the store nearest to the user or out of stock, then the user's effort is in vain. If this article is urgently required, the user finds it inconvenient.

### SUMMARY OF THE INVENTION

The present invention has been made in consideration of the above problems, and has as its object to provide an equipment management system which can efficiently make an equipment repair request and requests to purchase equipment and its expendables and reduce a burden in managing information about equipment, an equipment management apparatus, a control method therefor, and a computer-readable memory.

According to the present invention, the foregoing object is attained by providing an equipment management system comprising a user terminal owned by a user and a server managed by a maker that provides equipment and an expendable of the equipment for the user, the user terminal and the server being connected to each other through a network, the user terminal including first transmission means for transmitting failure information about equipment connected to the user terminal to the server, and the server including calculation means for calculating repair fee estimate of the equipment on the basis the failure information transmitted from the transmission means; and second transmission means for transmitting estimate information including the repair fee estimate calculated by the calculation means to the user terminal.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view showing the arrangement of an equipment management system according to an embodiment;

FIG. 2 is a flow chart showing a process accompanying online warranty registration in the equipment management system according to this embodiment;

FIG. 3 is a view showing an example of a failure content check table in this embodiment;

FIG. 4 is a view showing an example of the format of failure information and its concrete example in this embodiment;

FIG. 5 is a view showing an example of a repair content check table in this embodiment;

FIG. 6 is a view showing an example of a part specifying table in this embodiment;

FIG. 7 is a view showing an example of a delivery date specifying table in this embodiment;

FIG. 8 is a view showing an example of a repair fee calculation table in this embodiment;

FIG. 9 is a view showing an example of a fixed price table in this embodiment;

FIG. 10 is a view showing an example of estimate mail in this embodiment; and

FIG. 11 is a flow chart showing a process accompanying an online maintenance contract in the equipment management system according to this embodiment.

### DETAILED DESCRIPTION OF THE PREFERRED EMBODIMENT

The preferred embodiment of the present invention will be described in detail below with reference to the accompanying drawings.

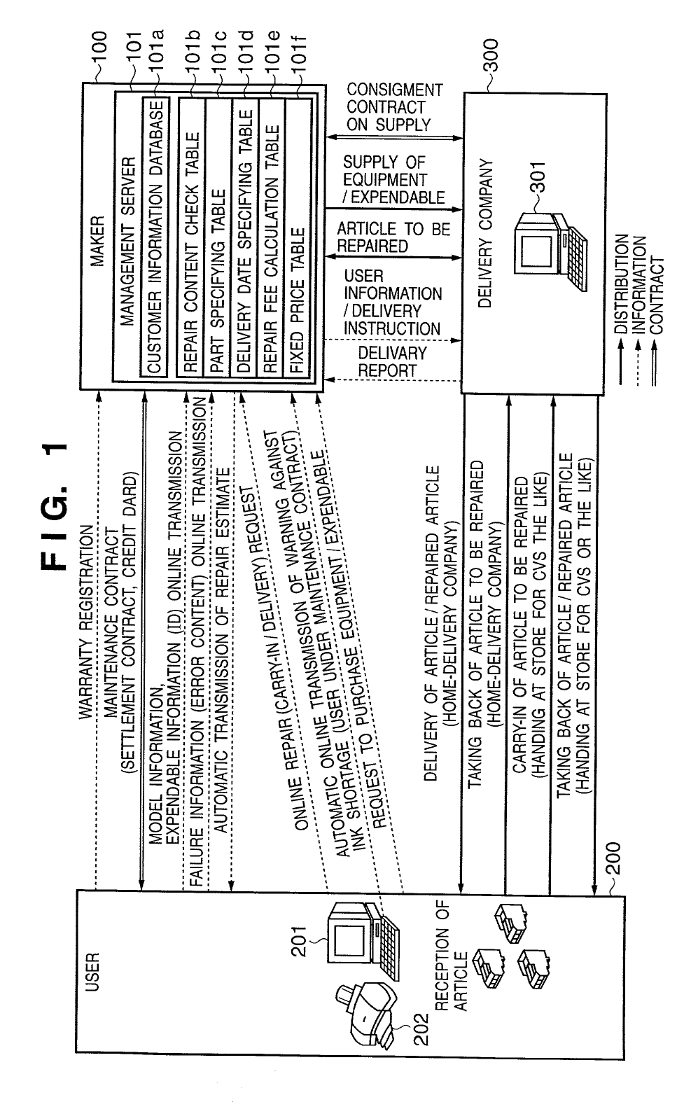

FIG. 1 is a view showing the arrangement of an equipment management system according to this embodiment.

In this embodiment, as equipment, an ink-jet printer for printing images by discharging ink will be described. However, the present invention can be applied to any equipment that uses expendables, e.g., a scanner, facsimile apparatus, copying machine, and terminal.

As shown in FIG. 1, in the equipment management system according to this embodiment, a maker 100, a user terminal 201 owned by a user 200, and a delivery company terminal 301 owned by a delivery company 300 are connected to each other through a network such as the Internet and can transmit/receive data to/from each other.

This equipment management system will be briefly described below. The maker 100 performs warranty registration/maintenance contract of equipment purchased by the user 200, a request to repair articles to be repaired, purchase of equipment and its expendables, and the like on dedicated sites constructed on the Web with respect to the user 200. Information about warranty registration/maintenance contract is collectively managed on the maker 100 side. For recovery of articles to be repaired from the user and delivery of repaired articles/equipment and expendables of the equipment to the user 200, the maker 100 signs a consignment contract with the delivery company 300, and makes arrangements, instructions, and the like for these operations on dedicated sites constructed on the Web. With this arrangement, the user 200 can efficiently request repair of articles to be repaired and purchase equipment and its expendables by using a terminal that can be connected to the Web. This makes it possible to save time and trouble for the user 200 and maker 100.

The function of each constituent element will be described in detail below.

The maker 100 has a management server 101, and manages warranty registration/maintenance contract of equipment, order receiving/sending operation, and the like through the network by using the management server 101.

The management server 101 has a Web server function, and provides various Web sites for warranty registration/maintenance contract of equipment, order receiving/sending operation, and the like. The management server 101 also has a customer information database 101a constituted by user information for managing the user 200 that performs warranty registration/maintenance contract. The management server 101 also stores a repair content check table 101b for checking the contents of a repair upon reception of a repair request, a part specifying table 101c for specifying parts for a repair target, a delivery date specifying table 101d for specifying the delivery date of a repaired article, a repair fee calculation table 101e for calculating a repair fee estimate, and a fixed price table 101f for specifying the price of an article to be repaired. These tables 101b to 101f will be described in detail later.

The user 200 has the user terminal 201 serving as at least a Web client, and can perform warranty registration/maintenance contract of equipment, order receiving/sending operation, and the like by using the Web sites provided by the management server 101. An ink-jet printer 202 is connected to the user terminal 201. The printer driver installed in the user terminal 201 monitors a failure in the ink-jet printer 202 and the state of the printer, e.g., an ink shortage. The printer driver can transmit failure information to the management server 101 when the ink-jet printer 202 (to be briefly referred to as the printer hereinafter) fails, and ink shortage information to the management server 101 when the printer runs out of ink.

The delivery company 300 has the delivery company terminal 301, and performs recovery of an article to be repaired or used expendable or delivery of equipment and its expendables from/to the user 200 in accordance with an instruction from the management server 101. The delivery company 300 then notifies the management server 101 of receipt reports on such recovery/delivery by using the delivery company terminal 301. Upon recovery of a repaired article or used expendable, the delivery company 300 delivers it to the maker 100.

The delivery company 300 is assumed to be a localized delivery company having quick delivery ability like a pizza home delivery company or the like. However, the present invention is not limited to this. This delivery company may be a transportation company that provides general home delivery services and the like. In addition, a convenience store (CVS), supermarket, or the like may be used as long as the user can carry/receive an article to be repaired, equipment, and its expendables.

Referring to FIG. 1, the dotted arrows indicate the flows of goods such as articles to be repaired, equipment, and its expendables that are exchanged between the respective constituent elements; the solid arrows, the flows of data transmitted/received between the respective constituent elements; and the double-line arrows, the flows of money exchanged between the respective constituent elements.

The user terminal 201 and delivery company terminal 301 have various constituent elements, e.g., CPUs, RAMs, ROMs, and the like, which constitute general-purpose computers such as a personal computer and workstation. The management server 101 is formed by a large scale computer such as a mainframe computer. The management server 101 and user terminal 201 are quipped with programs for executing the flow charts to be described later.

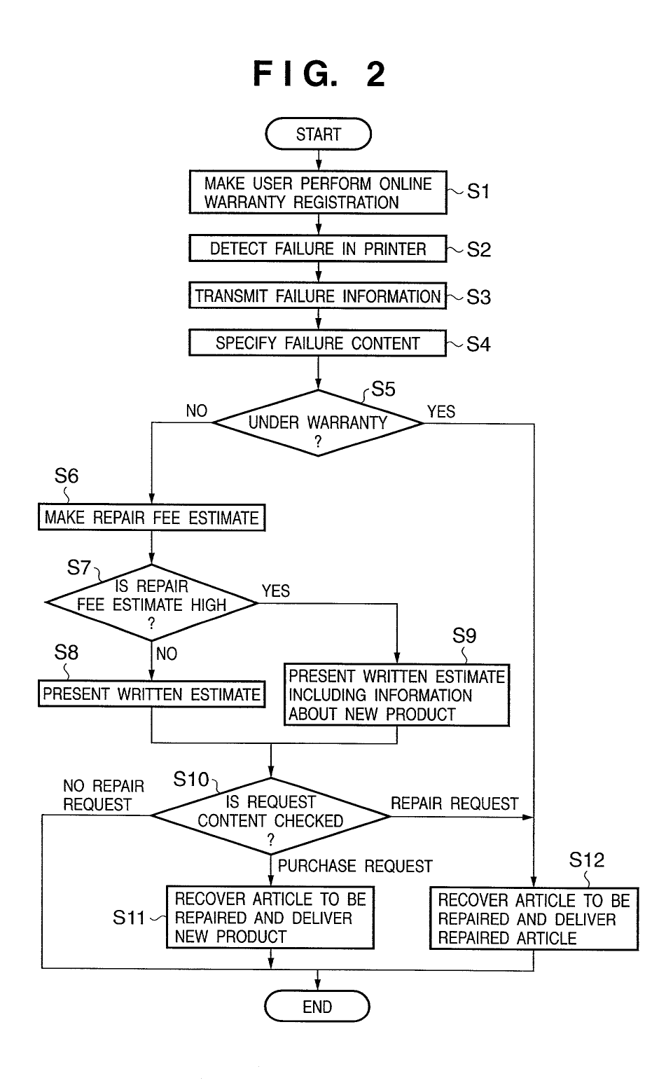

A process accompanying online warranty registration, of the processes executed by the equipment management system of this embodiment, will be described first with reference to FIG. 2.

FIG. 2 is a flow chart showing a process accompanying online warranty registration in the equipment management system of this embodiment.

In step S1, the user 200 operates the user terminal 201 to access a warranty registration site for receiving an online warranty registration service provided by the maker 100 and execute online warranty registration. In this online warranty registration, the user 200 inputs, through the user terminal 201, user information (the name, address, telephone number, age, sex, e-mail address, printer name, product No. of the printer 202, and the like), which is used by the maker 100 to manage the user 200, in accordance with the warranty registration site, thereby completing the online warranty registration. The input user information is registered in the customer information database 101a of the management server 101.

In step S2, when the ink-jet printer 202 connected to the user terminal 201 fails, the printer driver installed in the user terminal 201 looks up the failure content check table on the basis of the product No. of the ink-jet printer 202 stored in the user terminal 201 and an error code indicting the type of error notified from the ink-jet printer 202, thereby specifying the failure content. The printer driver then displays information indicating the occurrence of the failure and the specified failure content on the screen of the user terminal 201.

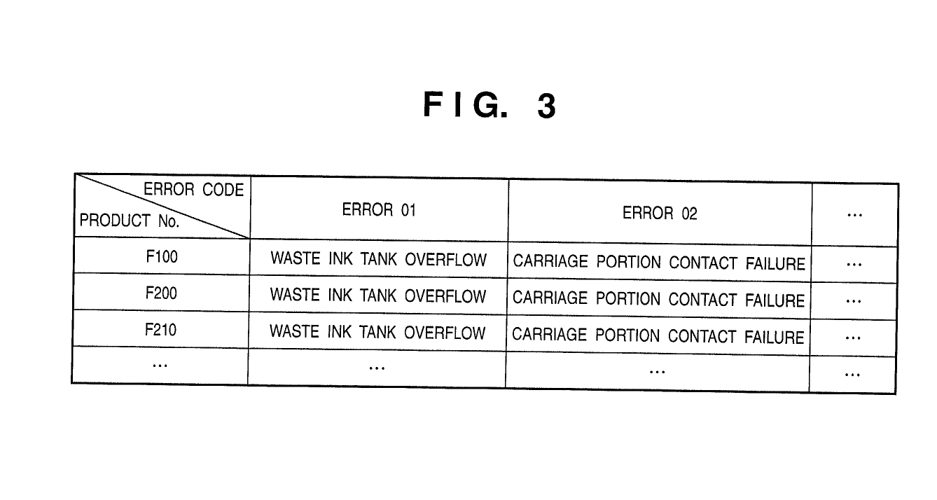

As shown in FIG. 3, in the failure content check table, product Nos., error codes, and failure contents are set in correspondence with each other. If, for example, the product No. is “F200” and the error code is “02”, the failure content can be specified as “carriage portion contact failure”. This failure content check table is stored in the user terminal 201 so that the printer driver can always look up the table as needed.

In step S3, the printer driver installed in the user terminal 201 outputs a connection request to the management server 101, and transmits user information for specifying the user to achieve user authentication. Thereafter, the printer driver transmits a failure information code formed by a combination of the above product No. and error code as failure information indicating a failure in the printer 202 to the management server 101.

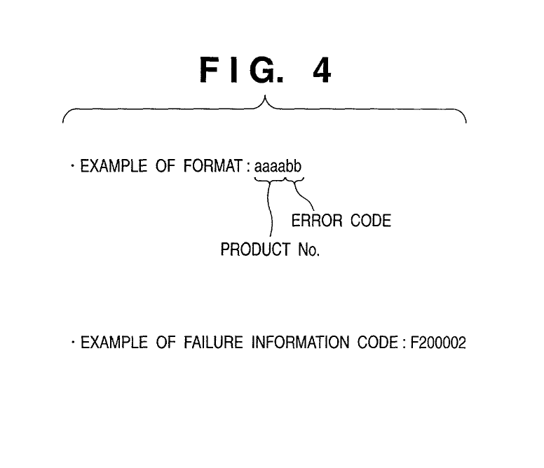

As shown in FIG. 4, the format of failure information is formed by 6 bits including a 4-bit product No. and a subsequent 2-bit error code. If, for example, the product No. is “F002” and the error code is “02”, the failure information code becomes “F20002”.

In step S4, the management server 101 looks up the repair content check table 101b on the basis of the failure information code received from the user terminal 201 to specify a repair content in the ink-jet printer 202.

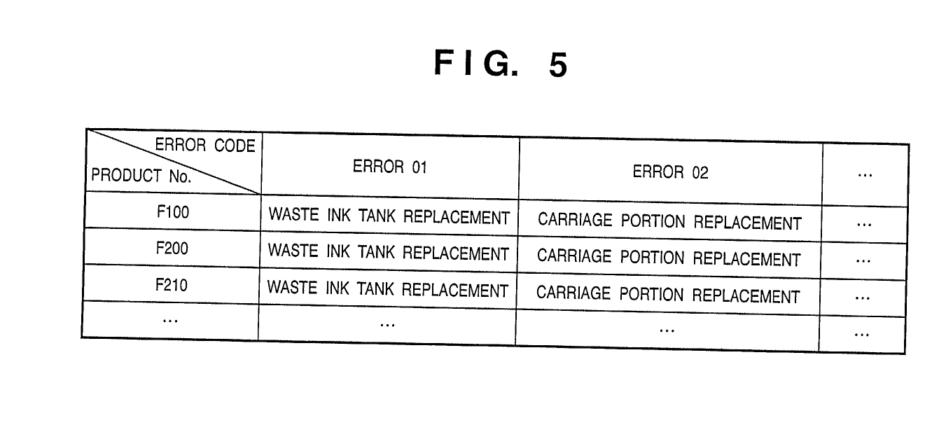

As shown in FIG. 5, in the repair content check table 10b, product Nos., error codes, and repair contents are arranged in correspondence with each other. If, for example, the failure information code received from the user terminal 201 is “F20002”, the upper 4 bits represent the product No. “F200” and the lower 2 bits represent the error code “02”. Hence, the repair content can be specified as “carriage replacement”.

In step S5, the management server 101 checks whether the printer 202 of the user 200 specified by looking up the customer information database 101a on the basis the user information received from the user terminal 201 is still under warranty. If the printer 202 is out of warranty (NO in step S5), the flow advances to step S6. If the printer 202 is under warranty (YES in step S5), the flow advances to step S12. In this case, the maker 100 repairs the printer 202 without charge. If the user has not made online warranty registration in spite of the fact that the printer 202 is still under warranty, online warranty registration is performed at this point of time or information indicating the printer 202 is under warranty is provided.

In step S6, the management server 101 specifies a part required for repair by looking up the part specifying table 101c on the basis of the received failure information code. The management server 101 then specifies the delivery date of the specified part by looking up the delivery date specifying 101d on the basis of the specified part. The management server 101 further calculates a repair fee estimate by looking up the repair fee calculation table 101e on the basis of the failure information code.

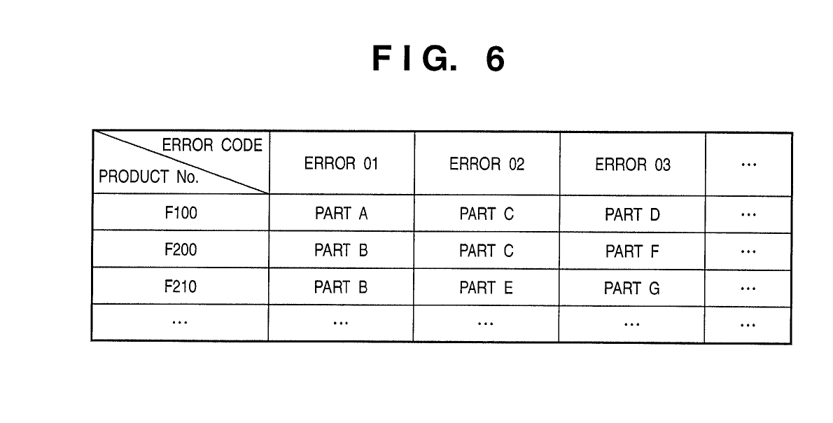

As shown in FIG. 6, in the part specifying table 101c, product Nos., error codes, and the types of parts are arranged in correspondence with each other. If, for example, the failure information code received from the user terminal 201 is “F20002”, the upper 4 bits represent the product No. “F200”, and the lower 2 bits represent the error code “02”. Therefore, the part required for repair can be specified as “part C”.

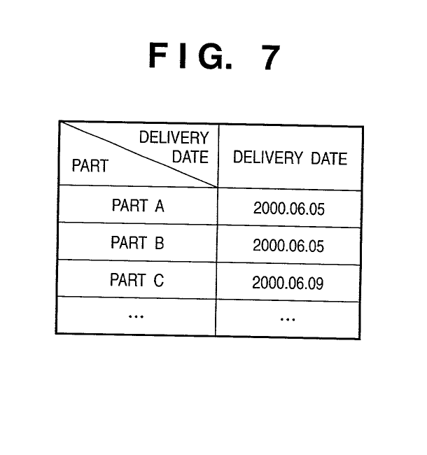

In the delivery date specifying table 101d, as shown in FIG. 7, the types of parts and delivery dates are arranged in correspondence with each other. If, for example, the part required for repair, which is specified by the above processing, is “part C”, the delivery date of the part can be specified as “2000.06.09”.

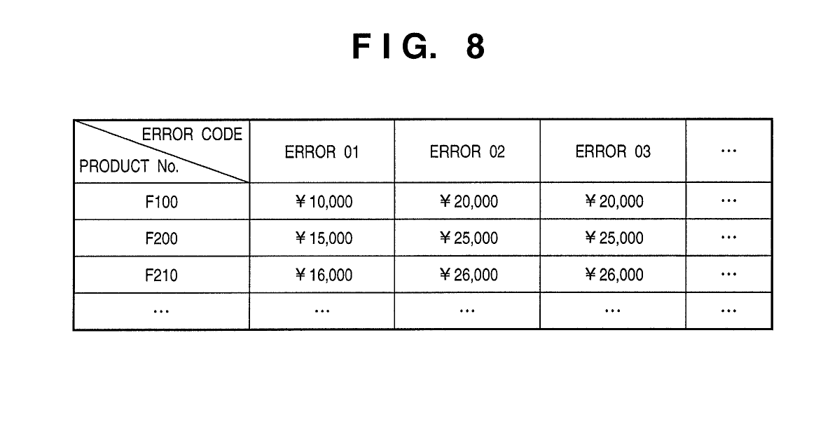

As shown in FIG. 8, in the repair fee calculation table 101e, product Nos., error codes, and repair fees are arranged in correspondence with each other. If, for example, the failure information code received from the user terminal 201 is “F20002”, the upper 4 bits represent the product No. “F200” and the lower 2 bits represents the error code “02”, the repair fee can be specified as “¥25,000”, which is set as a repair fee estimate.

In step S7, the management server 101 specifies the price of the printer 202 used by the user 200 by looking up the fixed price table 101f on the basis of the failure information code, and determines on the basis of the price and the formed repair fee estimate whether the repair fee estimate is high.

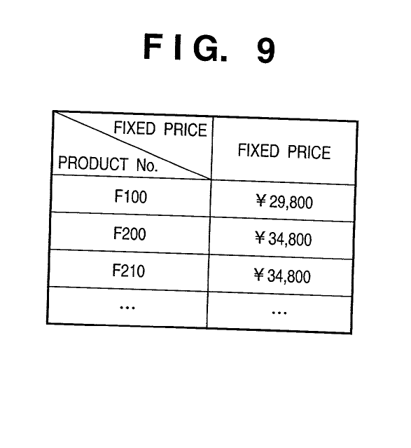

As shown in FIG. 9, in the fixed price table 101f, product Nos. and the prices of printers 202 corresponding to the product Nos. are arranged in correspondence with each other. If, for example, the failure information code received from the user terminal 201 is “F20002”, since the upper 4 bits represent the product No. “F200”, the price can be specified as “¥34,800”. To determine whether the repair fee estimate is high, the management server 101 checks whether the ratio of the repair fee estimate to the price is a predetermined value (e.g., 0.5) or more. In other words, it is checked whether the repair fee estimate is equal to or more than a predetermined value (half the fixed price). As this predetermined value, any value that makes the user determine that the repair fee estimate is high may be set. In this case, it is assumed that if the repair fee is half the fixed price, the user accepts repair. In the above case, the fixed price is “¥34,800”, and the repair fee estimate is “¥25,000”. Since the ratio becomes 25000/348000≈0.71≧0.5, it is determined that the repair fee estimate is high.

If it is determined in step S7 that the repair fee estimate is high (YES in step S7), the flow advances to step S9, in which the management server 101 forms an estimate including information about new products on the basis of the repair fee estimate, and transmits it as estimate mail to the user terminal 201. If it is determined that the repair fee estimate is not high (NO in step S7), the flow advances to step S8, in which the management server 101 forms an estimate on the basis of the repair fee estimate, and transmits it as estimate mail to the user terminal 201.

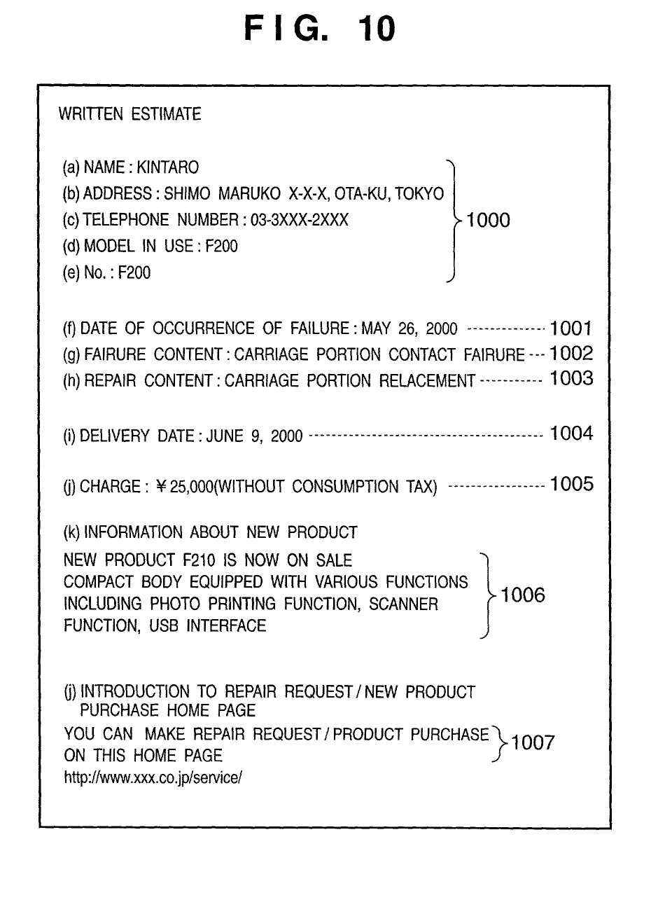

Estimate mail will be described below with reference to FIG. 10.

FIG. 10 shows an example of estimate mail in this embodiment.

Estimate mail is formed on the basis of the information obtained in each step described above. In the example shown in FIG. 10, the estimate mail is constituted by articles 1000 to 1007. Reference numeral 1000 denotes user information registered in the customer information database 101a; 1001, the date when a failure information code is transmitted from the user terminal 201 to the management server 101; 1002, the failure content specified in step S2; 1003, the repair content specified in step S4; 1004, the delivery date specified in step S6; 1005, the repair fee estimate calculated in step S6; 1006, the information about a new product to be written when it is determined in step S7 that the repair fee estimate is high; and 1007, information indicating a method of generating a repair request/new product purchase request. In this embodiment, as the information 1007, the URL of a repair request/new product purchase request site is written.

See FIG. 2 again.

In step S10, the user 200 checks the estimate mail received through the user terminal 201, and sends various requests to the management server 101 through the user terminal 201 on the basis of the estimate mail. In this embodiment, as these requests, three types of requests are assumed as follows:

1) The user 200 determines that the printer 202 is not repaired. In this case, the processing is terminated.

2) Since the repair fee estimate of the printer 202 is equal to or more than half the fixed price, the user 200 determines that a new printer is purchased. In this case, the user 200 accesses the repair request/new product purchase request site written in the estimate mail through the user terminal 201, and generates a request to purchase a printer in accordance with the repair request/new product purchase request site. The flow then advances to step S11.

In step S11, when the user 200 accesses the repair request/new product purchase request site through the user terminal 201, a window for designating a method of recovering the faulty printer 202 and a method of delivering the requested new printer is displayed on the user terminal 201. When the user 200 designates a method of recovering the faulty printer 202 and a method of delivering the requested new printer through the user terminal 201, the management server 101 transmits delivery information indicating the method of recovering the faulty printer 202 and the method of delivering the requested printer to the delivery company terminal 301 of the delivery company 300 under contract. The delivery company recovers the faulty printer 202 from the user 200 and delivers it to the maker 100, and also delivers the printer received from the maker 100 to the user 200 in accordance with the delivery information received through the delivery company terminal 301. When the delivery is completed, the delivery company notifies the management server 101 of a delivery completion report through the delivery company terminal 301.

3) The repair fee estimate of the printer 202 is less than half the fixed price, and hence the user determines that the printer may be repaired with the repair fee estimate in the estimate mail. In this case, the user 200 accesses the repair request/new product purchase request site written in the estimate mail, and generates a request to repair the printer 202 in accordance with the repair request/new product purchase request site. The flow then advances to step S12.

In step S12, when the user 200 accesses the repair request/new product purchase request site through the user terminal 201, a window for designating a method of recovering the article to be repaired and a method of delivering the repaired article is displayed on the user terminal 201. When the user 200 designates a method of recovering the article to be repaired and a method of delivering the repaired article through the user terminal 201, the management server 101 transmits delivery information indicating the method of recovering the article to be repaired and the method of delivering the repaired article to the delivery company terminal 301 of the delivery company 300 under consignment contract. The delivery company recovers the article to be repaired from the user 200 and delivers it to the maker 100, and also delivers the repaired article received from the maker 100 to the user 200 in accordance with the delivery information received through the delivery company terminal 301. When the delivery is completed, the delivery company notifies the management server 101 of a delivery completion report through the delivery company terminal 301.

In this embodiment, in addition to online warranty registration, an online maintenance contract for a purchased printer and its expendables can be made.

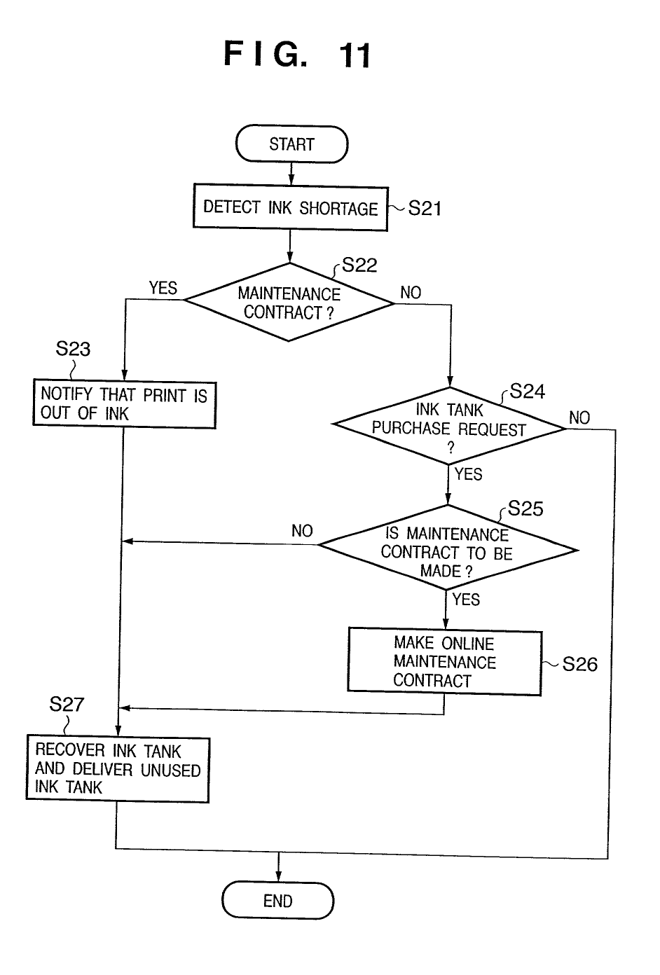

Processing that accompanies an online maintenance contract will be described below with reference to FIG. 11.

FIG. 11 is a flow chart showing processing that accompanies an online maintenance contract in the equipment management system according to this embodiment.

The flow chart in FIG. 11 exemplifies the case where an ink tank is treated as an expendable. However, any article can be treated as an expendable as long as it is an expendable of the printer 202 which can be detected by the printer driver installed in the user terminal 201, e.g., an ink cartridge as a combination of an ink-jet head and an ink tank.

In step S21, when the printer 202 connected to the user terminal 201 runs out of ink, the printer driver installed in the user terminal 201 displays, on the screen of the user terminal 201, information indicating that the printer has run out of ink.

In step S22, the printer driver installed in the user terminal 201 checks whether the user has made a maintenance contract for the printer 202 or its expendable. If a maintenance contract has been made (YES in step S22), the flow advances to step S23 to inform that the printer has run out of ink, and also inform the user terminal 201 of a request to supply an unused ink tank. The user terminal 201 then informs the management server 101 of the above information. The flow then advances to step S27. If no maintenance contract has been made (NO in step S22), the flow advances to step S24.

Note that an online maintenance contract is made when the user 200 inputs user information (the name, address, telephone number, age, sex, e-mail address, and printer and its expendables for the maintenance contract, and the like), which is used by the maker 100 to manage the user, through the user terminal 201 in accordance with the maintenance contract site provided by the management server 101. The input user information is registered in the customer information database 101a.

In step S24, the printer driver installed in the user terminal 201 displays, on the user terminal 201, a purchase request window having the URL of a purchase request site for ink tanks to check whether an ink tank purchase request is generated. If the user 200 will not generate an ink tank purchase request (NO in step S24), the processing is terminated. If the user 200 will generate an ink tank purchase request (YES in step S24), the user 200 accesses the purchase request site displayed on the purchase request window through the user terminal 201. The flow then advances to step S25.

On the purchase request side, the URL of the maintenance contract site for making an online maintenance contract is prepared, in addition to an ink tank purchase request. The user 200 can make an online maintenance contract at the same time when he/she makes an ink tank purchase request.

If it is determined in step S25 that no online maintenance contract is to be made (NO in step S25), the user 200 generates an ink tank purchase request and inputs user information on the purchase request site through the user terminal 201. The flow then advances to step S27. If an online maintenance contract is to be made (YES in step S25), the flow advances to step S26, in which the user 200 generates an ink tank purchase request on the purchase request site through the user terminal 201, and also accesses the maintenance contract site to make an online maintenance contract. Thereafter, the flow advances to step S27.

In step S27, upon reception of the notification of an ink shortage from the user terminal 201 of the user 200 who has made a maintenance contract, or an ink tank purchase request from the user terminal 201 of the user 200, the management server 101 transmits, to the delivery company terminal 301 of the delivery company 300 under consignment contract, delivery information indicating a method of recovering the waste ink tank and a method of delivering an unused ink tank. The delivery company recovers the waste ink tank from the user 200 and delivers it to the maker 100, and also delivers an unused ink tank handed from the maker 100 to the user 200 in accordance with the delivery information received through the delivery company terminal 301. When the delivery is completed, the delivery company notifies the management server 101 of a delivery completion report by using the delivery company terminal 301.

As has been described above, according to this embodiment, information about warranty registration/maintenance contracts is collectively managed on the network, and all operations between a maker and a user, e.g., operations associated with warranty registration/maintenance contract of equipment, equipment repair request, and requests to purchase equipment and its expendables, are performed on the Web on the basis of the information. This makes it possible to efficiently generate an equipment repair request and requests to purchase equipment and its expendables. In addition, the burden of management of information about equipment can be reduced on both the user and maker sides.

The present invention may be applied to a system constituted by a plurality of devices (e.g., a host computer, an interface device, a reader, a printer, and the like) or an apparatus comprising a single device (e.g., a copying machine, a facsimile apparatus, or the like).

The object of the present invention is realized even by supplying a storage medium storing software program codes for realizing the functions of the above-described embodiment to a system or apparatus, and causing the computer (or a CPU or an MPU) of the system or apparatus to read out and execute the program codes stored in the storage medium.

In this case, the program codes read out from the storage medium realize the functions of the above-described embodiment by themselves, and the storage medium storing the program codes constitutes the present invention.

As a storage medium for supplying the program codes, a floppy disk, a hard disk, an optical disk, a magnetooptical disk, a CD-ROM, a CD-R, a magnetic tape, a nonvolatile memory card, a ROM, or the like can be used.

The functions of the above-described embodiment are realized not only when the readout program codes are executed by the computer but also when the OS (Operating System) running on the computer performs part or all of actual processing on the basis of the instructions of the program codes.

The functions of the above-described embodiment are also realized when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

When the present invention is to be applied to the above storage medium, program codes corresponding to the flow charts of FIGS. 2 and 11 are stored in the storage medium.

As many apparently widely different embodiments of the present invention can be made without departing from the spirit and scope thereof, it is to be understood that the invention is not limited to the specific embodiments thereof except as defined in the appended claims.

What is claimed is:

1. An equipment management system comprising a user terminal owned by a user and a server managed by a maker that provides equipment and an expendable of the equipment for the user, said user terminal and said server being connected to each other through a network,
said user terminal including
first transmission means for transmitting failure information about equipment connected to said user terminal to said server, and
said server including
calculation means for calculating repair fee estimate of the equipment on the basis the failure information transmitted from said transmission means; and
second transmission means for transmitting estimate information including the repair fee estimate calculated by said calculation means to said user terminal.

2. The system according to claim 1, wherein said calculation means calculates a repair fee estimate of the equipment on the basis of a warranty period of the equipment.

3. The system according to claim 1, wherein the estimate information further includes one or both of a delivery date of a repaired article and a URL for a procedure for making a request to repair the equipment.

4. The system according to claim 1, wherein said calculation means comprises determination means for determining whether the repair fee estimate is not more than a predetermined value, and
said second transmission means further transmits the estimate information including information about a new product to said user terminal on the basis of the determination result obtained by said determination means.

5. The system according to claim 3, wherein the estimate information further includes a URL for a procedure for making a request to purchase the new product.

6. An equipment management system comprising a user terminal owned by a user and a server managed by a maker that provides equipment and an expendable of the equipment for the user, said user terminal and said server being connected to each other through a network,
said user terminal including
determination means for determining, on the basis of the remaining quantity of expendable of equipment connected to said user terminal, whether the user has made a maintenance contract for the expendable with the maker, and
notification means for notifying said server of a request to supply the expendable on the basis of the determination result obtained by said determination means.

7. The system according to claim 6, wherein if said determination means determines that the user has made no maintenance contract of the expendable with the maker, said notification means displays, on a display unit of said user terminal, a window for making a request to purchase the expendable.

8. The system according to claim 6, wherein said server comprises execution means for making an arrangement for supply of the expendable on the basis of the notification of the request to supply the expendable from said notification means.

9. A control method for an equipment management system in which a user terminal owned by a user and a server managed by a maker that provides equipment and an expendable of the equipment for the user are connected to each other through a network, comprising:
the first transmission step of transmitting failure information about equipment connected to the user terminal to the server;
the calculation step of calculating repair fee estimate of the equipment on the basis the failure information transmitted in the transmission step; and
the second transmission step of transmitting estimate information including the repair fee estimate calculated in the calculation step to the user terminal.

10. The method according to claim 9, wherein in the calculation step, a repair fee estimate of the equipment is calculated on the basis of a warranty period of the equipment.

11. The method according to claim 9, wherein the estimate information further includes one or both of a delivery date of a repaired article and a URL for a procedure for making a request to repair the equipment.

12. The method according to claim 9, wherein the calculation step comprises the determination step of determining whether the repair fee estimate is not more than a predetermined value, and
in the second transmission step, the estimate information including information about a new product is further transmitted to the user terminal on the basis of the determination result obtained in the determination step.

13. The method according to claim 11, wherein the estimate information further includes a URL for a procedure for making a request to purchase the new product.

14. A control method of an equipment management system in which a user terminal owned by a user and a server managed by a maker that provides equipment and an expendable of the equipment for the user are connected to each other through a network, comprising:
the determination step of determining, on the basis of the remaining quantity of expendable of equipment connected to the user terminal, whether the user has made a maintenance contract for the expendable with the maker; and
the notification step of notifying the server of a request to supply the expendable on the basis of the determination result obtained in the determination step.

15. The method according to claim 14, wherein if it is determined in the determination step that the user has made no maintenance contract of the expendable with the maker, a window for making a request to purchase the expendable is displayed on a display unit of the user terminal in the notification step.

16. The method according to claim 14, further comprising the execution step of making an arrangement for supply of the expendable on the basis of the notification of the request to supply the expendable in the notification step.

17. A computer-readable memory storing a program code for control on an equipment management system in which a user terminal owned by a user and a server managed by a maker that provides equipment and an expendable of the equipment for the user are connected to each other through a network, comprising:
a program code for the first transmission step of transmitting failure information about equipment connected to the user terminal to the server;
a program code for the calculation step of calculating repair fee estimate of the equipment on the basis the failure information transmitted in the transmission step; and
a program code for the second transmission step of transmitting estimate information including the repair fee estimate calculated in the calculation step to the user terminal.

18. A computer-readable memory storing a program code for a control on an equipment management system in which a user terminal owned by a user and a server managed by a maker that provides equipment and an expendable of the equipment for the user are connected to each other through a network, comprising:
a program code for the determination step of determining, on the basis of the remaining quantity of expendable of equipment connected to the user terminal, whether the user has made a maintenance contract for the expendable with the maker; and
a program code for the notification step of notifying the server of a request to supply the expendable on the basis of the determination result obtained in the determination step.

19. An equipment management apparatus which is connected to a user terminal owned by a user through a network and managed by a maker that provides equipment and an expendable of the equipment to the user, comprising:
calculation means for calculating a repair fee estimate of the equipment on the basis of failure information of the equipment connected to the user terminal which is transmitted from the user terminal; and
transmission means for transmitting estimate information including the repair fee estimate calculated by said calculation means to the user terminal.

20. The apparatus according to claim 19, wherein said calculation means calculates a repair fee estimate of the equipment on the basis of a warranty period of the equipment.

21. The apparatus according to claim 19, wherein the estimate information further includes one or both of a delivery date of a repaired article and a URL for a procedure for making a request to repair the equipment.

22. The apparatus according to claim 19, wherein
said calculation means comprises determination means for determining whether the repair fee estimate is not more than a predetermined value, and
said transmission means further transmits the estimate information including information about a new product to said user terminal on the basis of the determination result obtained by said determination means.

23. The apparatus according to claim 22, wherein the estimate information further includes a URL for a procedure for making a request to purchase the new product.

24. An equipment management apparatus to which a server managed by a maker that provides equipment and an expendable of the equipment to the user is connected, comprising:
determination means for determining, on the basis of the remaining quantity of expendable of equipment connected to the equipment management apparatus, whether a maintenance contract for the expendable is made with the maker; and
notification means for notifying said server of a request to supply the expendable on the basis of the determination result obtained by said determination means.

25. The apparatus according to claim 24, wherein if said determination means determines that no maintenance contract of the expendable is made with the maker, said notification means displays, on a display unit of said user terminal, a window for making a request to purchase the expendable.

26. The apparatus according to claim 24, wherein said server comprises execution means for making an arrangement for supply of the expendable on the basis of the notification of the request to supply the expendable from said notification means.

27. A control method for an equipment management apparatus which is connected to a user terminal owned by a user through a network and managed by a maker that provides equipment and an expendable of the equipment to the user, comprising:
the calculation step of calculating a repair fee estimate of the equipment on the basis of failure information of the equipment connected to the user terminal which is transmitted from the user terminal; and
the transmission step of transmitting estimate information including the repair fee estimate calculated in the calculation step to the user terminal.

28. The method according to claim 27, wherein in the calculation step, a repair fee estimate of the equipment is calculated on the basis of a warranty period of the equipment.

29. The method according to claim 27, wherein the estimate information further includes one or both of a delivery date of a repaired article and a URL for a procedure for making a request to repair the equipment.

30. The method according to claim 27, wherein the calculation step comprises the determination step of determining whether the repair fee estimate is not more than a predetermined value, and
in the transmission step, the estimate information including information about a new product is further transmitted to the user terminal on the basis of the determination result obtained in the determination step.

31. The method according to claim 30, wherein the estimate information further includes a URL for a procedure for making a request to purchase the new product.

32. A control method for an equipment management apparatus to which a server managed by a maker that provides equipment and an expendable of the equipment to the user is connected, comprising:
the determination step of determining, on the basis of the remaining quantity of expendable of equipment connected to the equipment management method, whether a maintenance contract for the expendable is made with the maker; and
the notification step of notifying the server of a request to supply the expendable on the basis of the determination result obtained in the determination step.

33. The method according to claim 32, wherein in the notification step, if it is determined in the determination step that no maintenance contract of the expendable is made with the maker, a window for making a request to purchase the expendable is displayed on a display unit of the equipment management apparatus.

34. The method according to claim 32, further comprising the execution step of making an arrangement for supply of the expendable on the basis of the notification of the request to supply the expendable in the notification step.

35. A computer-readable memory storing a program code for a control on an equipment management apparatus which is connected to a user terminal owned by a user through a network and managed by a maker that provides equipment and an expendable of the equipment to the user, comprising:
a program code for the calculation step of calculating a repair fee estimate of the equipment on the basis of failure information of the equipment connected to the user terminal which is transmitted from the user terminal; and
a program code for the transmission step of transmitting estimate information including the repair fee estimate calculated in the calculation step to the user terminal.

36. A computer-readable memory storing a program code for control on an equipment management apparatus to which a server managed by a maker that provides equipment and an expendable of the equipment to the user is connected, comprising:
a program code for the determination step of determining, on the basis of the remaining quantity of expendable of equipment connected to the equipment management method, whether a maintenance contract for the expendable is made with the maker; and
a program code for the notification step of notifying the server of a request to supply the expendable on the basis of the determination result obtained in the determination step.

37. An equipment management apparatus, comprising:
calculation means for calculating an estimate on the basis of failure information from the equipment; and
notification means for making a notification of information about a new product, together with the estimate, if the estimate calculated by said calculation means is not less than a predetermined value.

38. An equipment management apparatus, comprising:
means for automatically ordering the expendable if the remaining quantity of expendable becomes not more than a predetermined value and a maintenance contract has been made; and
means for ordering the expendable by making a user choose between ordering the expendable and not ordering the expendable if the remaining quantity becomes not more than the predetermined value and no maintenance contract has been made.

39. A control method for an equipment management apparatus, comprising:
the calculation step of calculating an estimate on the basis of failure information from the equipment; and
the notification step of making a notification of information about a new product, together with the estimate, if the estimate calculated in the calculation step is not less than a predetermined value.

40. A control method for an equipment management apparatus, comprising:
the step of automatically ordering the expendable if the remaining quantity of expendable becomes not more than a predetermined value and a maintenance contract has been made; and
the step of ordering the expendable by making a user choose between ordering the expendable and not ordering the expendable if the remaining quantity becomes not more than the predetermined value and no maintenance contract has been made.

41. A computer-readable memory storing an equipment management program, comprising:
the calculation step of calculating an estimate on the basis of failure information from the equipment; and
the notification step of making a notification of information about a new product, together with the estimate, if the estimate calculated in the calculation step is not less than a predetermined value.

42. A computer-readable memory storing an equipment management program, comprising:
the step of automatically ordering the expendable if the remaining quantity of expendable becomes not more than a predetermined value and a maintenance contract has been made; and
the step of ordering the expendable by making a user choose between ordering the expendable and not ordering the expendable if the remaining quantity becomes not more than the predetermined value and no maintenance contract has been made.
